(19) United States
(12) Patent Application Publication
(10) Pub. No.: US 2006/0191839 A1
(43) Pub. Date: Aug. 31, 2006

(54) High capacity filter element

(76) Inventors: James A. Howard, Houston, TX (US); Clay Cravens, Houston, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 11/386,601

(22) Filed: Mar. 22, 2006

Related U.S. Application Data
(63) Continuation of application No. 10/348,528, filed on Jan. 20, 2003, now abandoned.

(51) Int. Cl. B01D 29/00

(52) U.S. Cl. 210/338; 210/450; 210/451

(57) ABSTRACT

A filter element is provided for high capacity liquid filtration. The filter element includes an outer filter and an inner filter having a diameter smaller than a diameter of the outer filter and positioned within the outer filter forming a passageway therebetween. The filter element also includes an outer filter support and an inner filter support. A first seal cap is positioned on a first side of the inner and outer filters and a second seal cap is positioned on a second side of the inner and outer filters opposite the first seal cap. The inner filter support is positioned within the inner filter and the outer filter is positioned within the outer filter support. The first seal cap is secured to the first side of the inner and outer filters and the inner and outer filter supports. The second seal cap is secured to the second side of the inner and outer filters and the inner and outer filter supports such that a liquid flows into the filter element through the first seal cap and through the passageway to the second seal cap whereby particles within the liquid are removed by the inner and outer filters.

### CROSS-REFERENCE TO RELATED APPLICATIONS

The instant application is a continuation of Ser. No. 10/348,528, filed Jan. 20, 2003, still pending, to which application priority is hereby claimed.

### FIELD OF THE INVENTION

The present invention relates generally to filter elements and, more specifically, to a high capacity filter element cartridge designed for liquid filtration which provides increased filter media surface area for high liquid flow capacity.

### DESCRIPTION OF PRIOR ART

There are numerous filtering mechanisms provided in the prior art. Typical prior art filters have a housing with a filter element contained therein. The housing has an opening for filtered liquid to enter and an opening for liquid to leave. These filter housings generally may have one or more filter elements contained within the housing, and the filter elements may be arranged in varying configurations. While prior art filters may be suitable for the purposes to which they address, they would not be as suitable for the purposes of the present invention as heretofore described.

### SUMMARY OF THE PRESENT INVENTION

The present invention relates generally to filter elements and, more specifically, to a high capacity filter element cartridge designed for liquid filtration which provides increased filter media surface area for high liquid flow capacity.

A primary object of the present invention is to provide a filter element able to overcome the shortcomings of the prior art for use in high capacity liquid filtration.

Another object of the present invention is to provide a filter element.

Further object of the present invention is to provide a filter element having an increased filter media surface area over that conventional of filter elements.

Another object of the present invention is to provide a filter element for high capacity liquid filtration having two filters.

Another object of the present invention is to provide a filter element for high capacity liquid filtration having two filters whereby a first filter is positioned within a second filter having a diameter larger than the diameter of the first filter in a concentric arrangement.

Yet another object of the present invention is to provide a filter element for high capacity liquid filtration that includes an outer circular corrugation of filter material and an inner non-connected circular corrugation of filter material.

A further object of the present invention is to provide a filter element for high capacity liquid filtration that includes and a first and second seal plate for holding the inner and outer filter material in a concentric arrangement.

Still yet another object of the present invention is to provide a filter element for high capacity filtration whereby unfiltered liquid enters in the space between the inner and outer filter media and flows radially outward through the outer filter and radially inward through the inner filter.

Still another object of the present invention is to provide a filter element for high capacity filtration that includes a perforated support member positioned concentrically within the inner filter media and perforated support member positioned around the outer filter media.

Yet another object of the present invention is to provide a filter element for high capacity liquid filtration including a coupler whereby the filter element can be manufactured to an extended length to add more filter surface area for filtering solid particles.

Another object of the present invention is to provide a filter element for high capacity liquid filtration that is simple and easy to use.

A still further object of the present invention is to provide a filter element for high capacity liquid filtration that is economical in cost to manufacture.

Additional objects of the present invention will appear as the description proceeds.

The present invention overcomes the shortcomings of the prior art by providing a filter element for high capacity liquid filtration where the outer corrugation and inner corrugated filter media are held in a concentric arrangement by an integral first seal cap with sufficient spacing to maximize filter media surface area without compromising flow capability of the filter.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

### BRIEF DESCRIPTION OF THE DRAWING FIGURES

In order that the invention may be more fully understood, it will now be described, by way of example, with reference to the accompanying drawing in which:

FIG. 1 is a perspective view of filter element of the present invention in use;

FIG. 2 is a perspective view of the filter element of the present invention;

FIG. 3 is a side view of the filter element of the present invention showing the outer and inner filters;

FIG. 4 is detailed cross-sectional view of the filter element of the present invention;

FIG. 5 is a detailed partial cross sectional view of the filter element present invention;

FIG. 6 is a perspective view of the filter and outer filter of the filter element of the present invention;

FIG. 7 is a cutaway view of the filter element of the present invention having couplers for extension thereof;

FIG. 8 is a cutaway view of the filter element of the present invention having multiple couplers for extension thereof;

FIG. 9 is a cutaway view of the filter element of the present invention having multiple couplers for extension thereof;

FIG. 10 is a cutaway view of the filter element of the present invention showing particle accumulation thereon; and

FIG. 11 is a side view of the filter element of the present invention having an alternate means for support.

### DETAILED DESCRIPTION OF THE REFERENCED NUMERAL

Turning now descriptively to the drawings, in which similar reference characters denote similar elements throughout the several views, the Figures illustrate the filter element for high capacity liquid filtration. With regard to the reference numerals used, the following numbering is used throughout the various drawing Figures.

10 filter element of the present invention

12 outer filter

13 filtering compartment

14 inner filter

16 inlet

18 first seal cap

19 first opening

20 housing

22 unfiltered liquid

23 filtered liquid

24 outlet

26 Pressure Gauges

28 securing means

30 second seal cap

31 second opening

32 cap handle

34 flow diverter

36 inner filter support means

38 outer filter support means

40 outer filter coupler

42 inner filter coupler

44 solid material

46 alternate support means

48 alternate outer filter support

50 alternate inner filter support

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

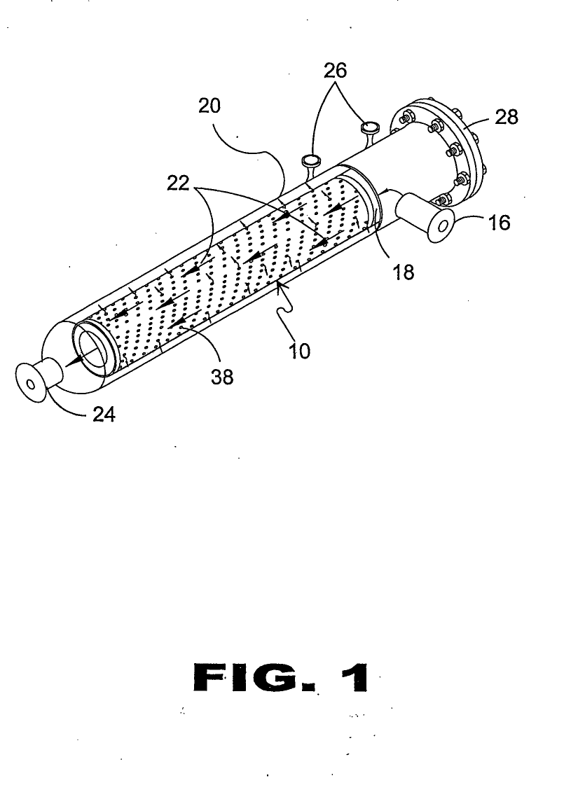

Turning now descriptively to the drawings, in which similar reference characters denote similar elements throughout the several views, FIGS. 1 through 11 illustrate the filter element of the present invention indicated generally by the numeral 10.

FIG. 1 is a perspective is view of filter element 10 of the present invention in use. The filter element 10 of the present invention is designed for high capacity liquid filtration. The filter element 10 is positioned inside a housing 20. The housing 20 has an inlet 16 and an outlet 24. The inlet 16 receives the liquid indicated generally by the arrows labeled with the numeral 22 for filtering thereof. The filtered liquid exits the filter element 10 through the outlet 24. The housing 20 further includes pressure gauges 26. The pressure gauges display the pressure of the liquid 22 passing through the filter element 10.

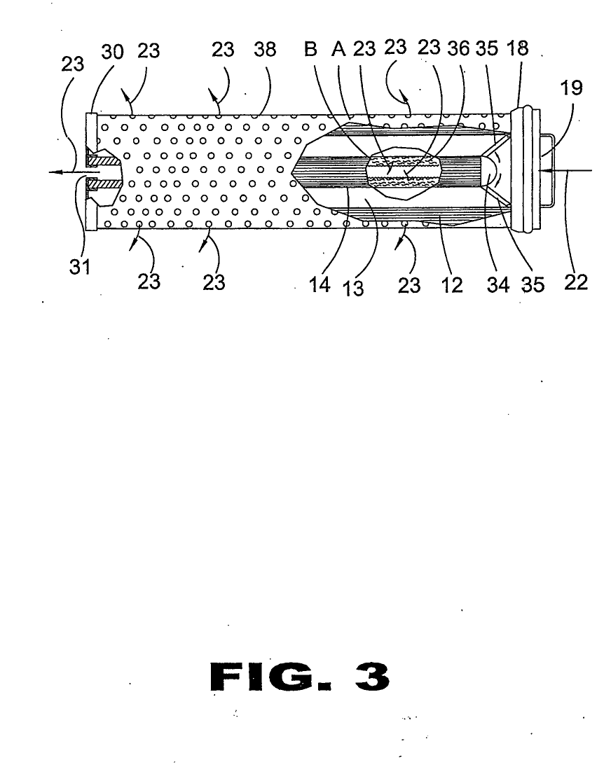

As can be seen from FIG. 3, the filter element 10 of the present invention includes an inner filter 14. The inner filter 14 is placed concentrically within an outer filter 12. The inner filter 14 has a diameter less than the diameter of the outer filter 12. The inner filter 14 and the outer filter 12 are preferably corrugated. However, any material or design capable of handling high capacity liquid filtration can be used. The inner filter 14 is supported by an inner filter support 36. The outer filter 12 is supported by an outer filter support 38. The filters 12,14 and their respective supports 36 and 38 are held in place by a first seal cap 18 and a second seal cap 30.

The first seal cap 18 has a first opening 19 selectively allowing liquid 22 to flow freely therethrough. The second seal cap 30 has a second opening 31 selectively allowing filtered liquids 23 to flow freely therethrough. The liquid 22 to be filtered enters the filter element 10 a high rate of flow through the first opening 19 in the first seal cap 18. The liquid 22 flows into the space 13 between the inner filter 14 and the outer filter 12. Thereafter, the liquid 22 passes radially outward through the outer filter 12 and radially inward through the inner filter 14. The filtered liquid 23 filtered by the inner filter 14 then exits through the inner support means 36 through the second opening 31 in the second seal cap 30. The filtered liquid 23 then exits the housing through the outlet 24. The, filtered liquid 23 filtered by the outer filter 12 then exits into the housing 20 through the outer support means 38. The liquid filtered 23 by the outer filter 12 then exits the housing 20 through the outlet 24.

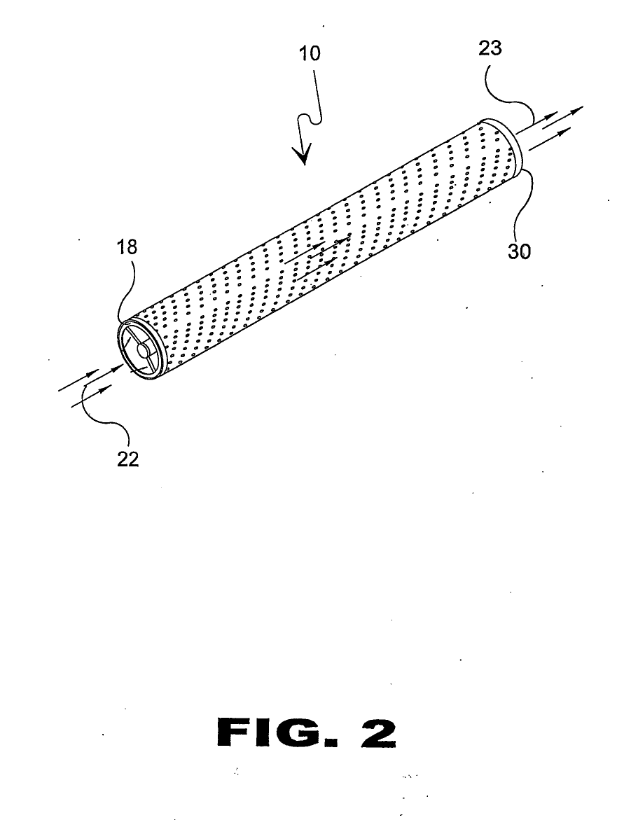

FIG. 2 is an illustrative view of the assembled filter element of the present invention. The filter element 10 includes an inner filter 14 and an outer filter 12. The inner filter 14 is placed concentrically within the outer filter 12. The inner filter 14 has a diameter less than the diameter of the outer filter 12. The inner filter 14 and the outer filter 12 are preferably corrugated. The inner filter is supported by an inner filter support 36. The outer filter 12 is supported by an outer filter support 38. The filters 12,14 and their respective supports 36,38 are held in place by a first seal cap 18 and a second seal cap 30 respectively.

FIG. 3 is a cutaway view of the filter element of the present invention showing the outer and inner filters 12 and 14 respectively. The filter element 10 includes the inner filter 14. The inner filter 14 is placed concentrically within the outer filter 12. The inner filter 14 has a diameter less than the diameter of the outer filter 12. The inner filter 14 and the outer filter 12 are preferably corrugated. The inner filter is supported by an inner filter support 36. The outer filter 12 is supported by an outer filter support 38. The filters 12, 14 and their respective supports 36,38 are held in place by a first seal cap 18 and a second seal cap 30 respectively.

The cutaway section labeled ‘A’ in FIG. 3 shows the inner corrugated filter 14 and the outer corrugated filter 12. Also shown in this Figure is the first seal cap 18. The first seal cap 18 includes flow diverter 34. The flow diverter is positioned over the inner filter 14 thereby preventing unfiltered liquid 22 from mixing with filtered liquid 23. The first seal cap 18 also includes a Stabilizer 35. The stabilizer 35 connects the flow diverter to the seal cap 18.

The arrows labeled with the numeral 23 represent the liquid passing through the outer filter and out of the filter element 10. The liquid 22 flows into the filter element 10 through the opening 19 in the first seal cap 18 at a high flow. The flow diverter 34 evenly spreads the liquid 22 into the space 13 between the inner corrugated filer 14 and the outer corrugated filter 12. The liquid 22 is then filtered by both the inner corrugated filter 14 and the outer corrugated filter 12 as it passes through the filter element.

The liquid 22 passing through the inner corrugated filter 14 passes through an inner support 36. The inner support 36 has perforations allowing liquid to pass therethrough. This is shown in the cutaway section labeled ‘B’ in FIG. 3 showing the inner support 36 located within the inner corrugated filter 14. The liquid 22 flows radially inward to the inner supports 36. The liquid 22 flows in the direction from the first seal cap 18 to the second seal cap 30. The filtered liquid 23 flowing through the inner support 36 exits the filter element 10 through a second opening 31 located in the second seal cap 30 and enters the housing 20. The filtered liquid 23 then exits the housing 20 via outlet 24.

The filtered liquid 23 passing through the outer corrugated filter 12 passes through the outer support 38. The outer support 38 includes perforations extending therethrough to allow liquid 23 to pass. The filtered liquid 23 passes through the outer support 38 and into the housing 20 which encloses the filter element 10. The filtered liquid 23 then exits the housing 20 via outlet 24.

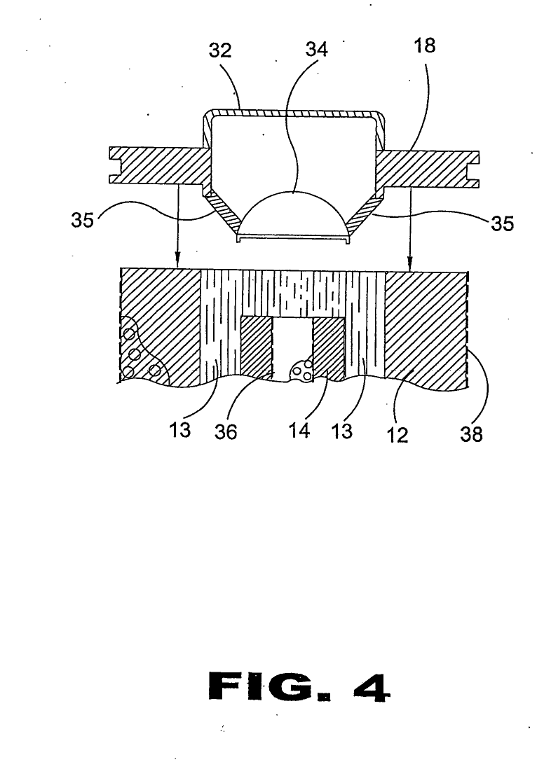

FIG. 4 is detailed cross-sectional view of the first seal cap 18 of the filter element 10 of the present invention. The first seal cap 18 includes a flow diverter 34. The flow diverter 34 is positioned over the inner filter 14 thereby preventing unfiltered liquid 22 from mixing with filtered liquid 23. The first seal cap 18 also includes a stabilizer 35. The stabilizer 35 connects the flow diverter 34 to the seal cap 18. The first seal cap 18 also includes a handle 32. The handle 32 facilitates removal of the filter element 10 from the housing 20.

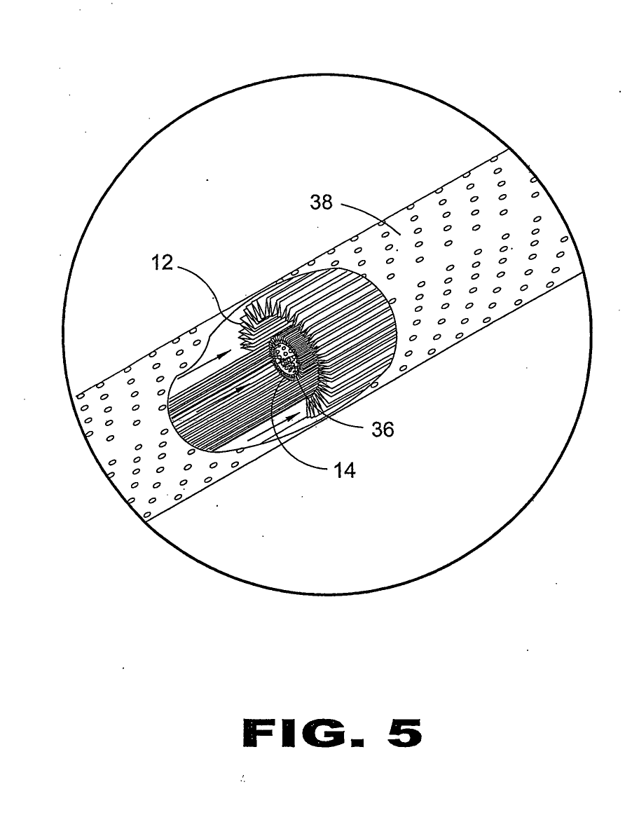

FIG. 5 is a detailed sectional view of the filter element 10 of the present invention. The filter element 10 includes the inner filter 14 and an outer filter 12. The inner filter 14 is placed concentrically within the outer filter 12. The inner filter 14 has a diameter less than the diameter of the outer filter 12. The inner filter 14 and the outer filter 12 are preferably corrugated. The inner filter is supported by an inner filter supports 36. The outer filter 12 is supported by an outer filter support 38. The liquid 22 passing therethrough is filtered by the inner filter 14 and the outer filter 12 causing any solids to remain within the chamber created by inner filter 14 and outer filter 12 and therefore removed from the filtered liquid. The liquid 23 filtered by the inner filter 14 flows radially inward through to the inner support 36. The liquid filtered by the outer filter 12 flows radially outward through the outer support 38.

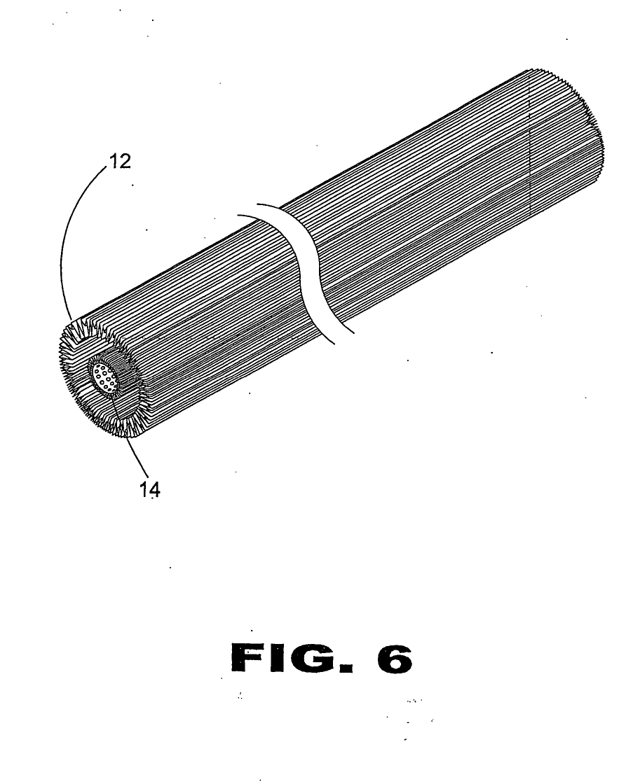

FIG. 6 is a perspective view of the filter element of the present invention. The filter element 10 includes an inner filter 14 and an outer filter 12. The inner filter 14 is placed concentrically within the outer filter 12. The inner filter 14 has a diameter less than the diameter of the outer filter 12. The inner filter 14 and the outer filter 12 are preferably corrugated. The inner filter is supported by an inner filter supports 36. The outer filter is supported by an outer filter support 38. The inner filter 14 and the outer filter 12 are shown without a housing 20. The filters 12, 14 are formed from corrugated filter media. Both the outer filter 12 and the inner filter 14 have a varying corrugation height utilizing a ‘M’ style design. This design is advantageous for a filtering apparatus as the ‘M’ style allows for the liquid passing therethrough to be exposed to a larger surface area of the filter. Increased surface area allows more impurities to be removed from the liquid being filtered.

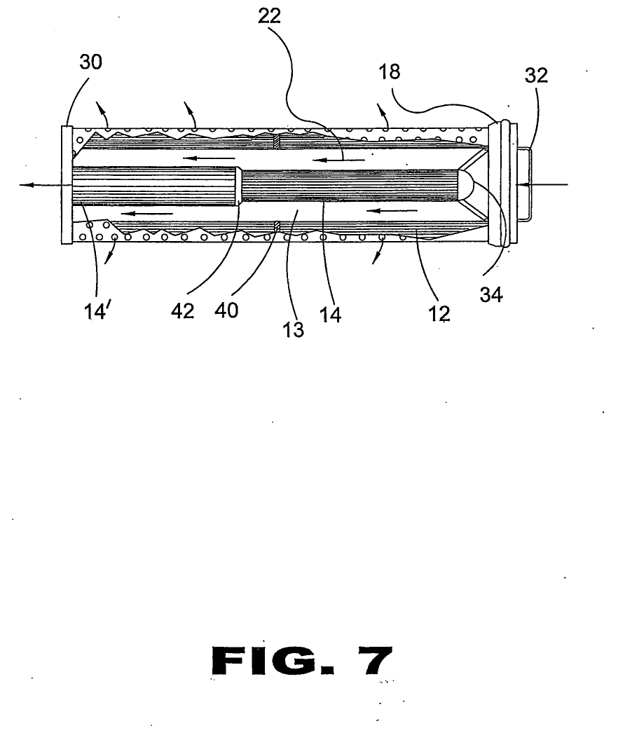

FIG. 7 is a cutaway view of the filter element of the present invention having couplers for extension thereof. The filter element 10 includes an inner filter 14 and an outer filter 12. The inner filter 14 is placed concentrically within the outer filter 12. The inner filter 14 has a diameter less than the diameter of the outer filter 12. The inner filter 14 and the outer filter 12 are preferably corrugated. The inner filter is supported by an inner filter support means 36. The outer filter 12 is supported by an outer filter support 38. The filters 12,14 and their respective supports 36,38 are held in place by a first seal cap 18 and a second seal cap 30 respectively. The filter element 10 of the present invention can also be extended to provide additional filter media. The filter media is extended by connecting an inner filter coupler 42 to the inner filter 14 at a position away from the first seal cap 18. A second inner filter 14′ is connected to the inner filter coupler 42 thereby extending the length of the inner filter of the filter element 10. An outer filter coupler 40 may also be connected to the outer filter 12 on a side away from the first seal cap 18 to increase the length of the outer filter. A second outer filter 12′ is attached to the coupler 40 thereby extending the length of the outer filter of the filter element 10. The outer coupler 40 and the inner coupler 42 can be secured to their respective filters 12,14 by either a thermal bond or an adhesive such as glue. However, any means capable of securing the couplers 40,42 to their respective filters 12,14 can be used. The filter media extensions 12′ and 14′ could be used with supports 36,38 having lengths longer than the lengths of the filters 12,14. Alternatively, the filter media extensions 12′,14′ could have their own supports 36′,38′. When the filter element 10 of the present invention is extended, the second seal cap 30 is positioned on an end of the second outer filter and second inner filters 12′,14′ opposite the outer coupler 40 and inner coupler 42.

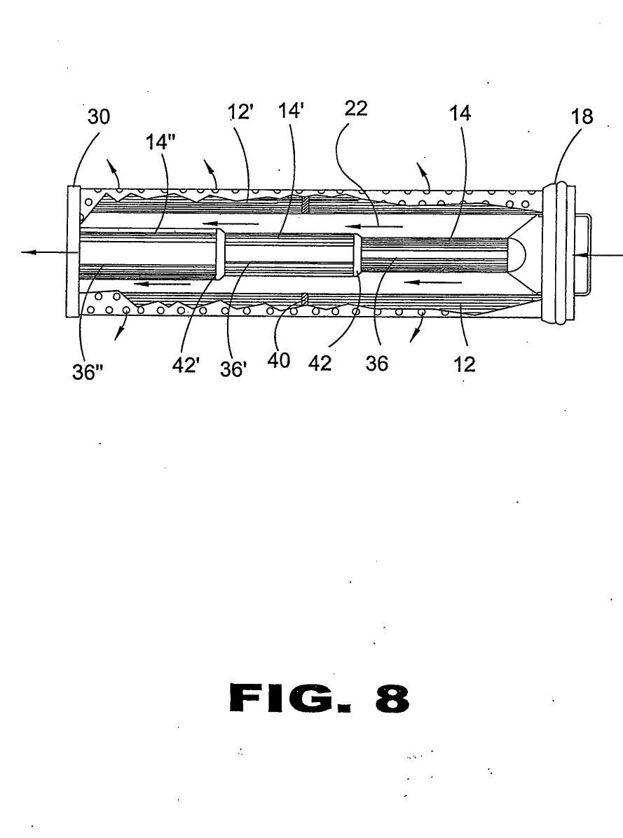

FIG. 8 is a cutaway view of the filter element of the present invention having multiple couplers for extension thereof. The filter element 10 includes an inner filter 14 and an outer filter 12. The inner filter 14 is placed concentrically within the outer filter 12. The inner filter 14 has a diameter less than the diameter of the outer filter 12. The inner filter 14 and the outer filter 12 are preferably corrugated. The inner filter is supported by an inner filter support 36. The outer filter is supported by an outer filter support 38. The filters 12,14 and their respective supports 36,38 are held in place by a first seal cap 118 and a second seal cap 30 respectively. The filter element 10 of the present invention can also be extended with multiple couplers to provide additional filter media. The filter media is extended by connecting an inner filter coupler 42 to the inner filter 14 on an end away from the first seal cap 18. A second inner filter 14′ is connected to the inner filter coupler 42 thereby extending the length of the inner filter of the filter element 10. The diameter of the second inner filter 14′ may be greater than that of the first inner filter 14. An outer filter coupler 40 is also connected to the outer filter 12 on a side away from the first seal cap 18. A second outer filter 12′ is connected to the coupler 40 thereby extending the length of the outer filter of the filter element 10. The outer coupler 40 and the inner coupler 42 can be secured to their respective filters 12,14 by either a thermal bond or an adhesive such as glue. However, any means capable of securing the couplers 40,42 to their respective filters 12,14 can be used. The filter element 10 of the present invention can be further extended in length by adding a second outer coupler 40′ and a second inner coupler 42′. The second outer coupler 40′ is connected to the second outer filter 12′. A third outer filter 12″ is then connected to the second outer coupler 40′. The second inner coupler 42′ is connected to the second inner filter 14′. A third inner filter 14″ is then connected to the second inner coupler 42′. The third inner filter 14″ may have a diameter greater than both the second inner filter 14′ and the first inner filter 14. The diameter of the second inner filter 14′ may be greater than the diameter of the first inner filter and less than the diameter of the third inner filter 14″, this allows for less resistance as liquid flows further through the filter element. Also, the larger diameter exposes the liquid 22 to a greater filter surface area thereby removing more impurities from the liquid 22. The second and third inner filters 14′,14″ could be used with supports 36′,36″ that have larger diameters. Alternatively, the filter media extensions 14′,14″ could have their own support means 36′,36″. When the filter element 10 is in a fully extended position, the second seal cap 30 is positioned on an end of the third outer and inner filters 12″,14″ opposite the outer coupler 40 and second inner coupler 42′.

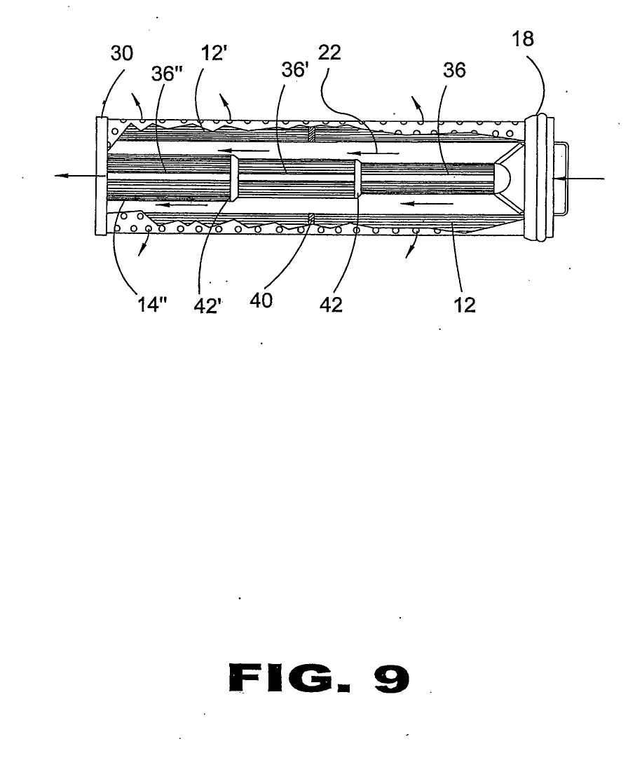

FIG. 9 is a cutaway view of the filter element of the present invention having multiple couplers for extension thereof. The filter element 10 includes an inner filter 14 and an outer filter 12. The inner filter 14 is placed concentrically within the outer filter 12. The inner filter 14 has a diameter less than the diameter of the outer filter 12. The inner filter 14 and the outer filter 12 are preferably corrugated. The inner filter is supported by an inner filter support 36. The outer filter 12 is supported by an outer filter support 38. The filters 12,14 and their respective support 36,38 are held in place by a first seal cap 18 and a second seal cap 30 respectively. The filter element 10 of the present invention can also be extended to provide additional filter media. The filter media is extended by connecting an inner filter coupler 42 to the inner filter 14 on an end away from the first seal cap 18. A second inner filter 14′ is connected to the inner filter coupler 42 thereby extending the length of the inner filter of the filter element 10. The diameter of the second inner filter 14′ is greater than that of the first inner filter 14. An outer filter coupler 40 is also connected to the outer filter 12 on a side away from the first seal cap 18. A second outer filter 12′ is connected to the coupler 40 thereby extending the length of the outer filter of the filter element 10 of the present invention. The outer coupler 40 and the inner coupler 42 can be secured to their respective filters 12,14 by either a thermal bond or an adhesive such as glue. However, any means capable of securing the couplers 40,42 to their respective filters 12,14 can be used. The filter element 10 of the invention can be further extended in length by adding a second outer coupler 40′ and a second inner coupler 42′. The second outer coupler 40′ is connected to the second outer filter 12′. A third outer filter 12″ is then connected to the second outer coupler 40′. The second inner coupler 42′ is connected to the second inner filter 14′. A third inner filter 14″ is then connected to the second inner coupler 42′. The second inner filter 14′ preferably and the third inner filter 14″ have the same diameter as the first inner filter 14. The second and third outer filters 12′,12″ and the second and third inner filters 14′,14″ could be used with supports 36,38 having lengths longer than the lengths of the filters 12,14. Alternatively, the filter media extensions 12′,14′ could have their own supports 36′;38′. When the filter element 10 is fully position extended, the second seal cap 30 is positioned on an end of the third outer and inner filters 12″,14″ opposite the second outer coupler 40′ and second inner coupler 42′.

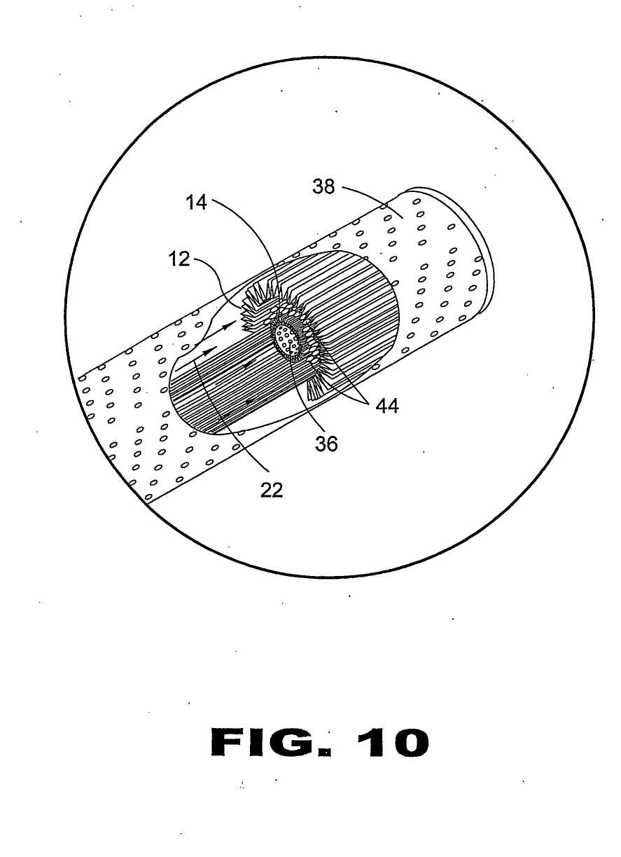

FIG. 10 is a cutaway view of the filter element of the present invention showing particle accumulation thereon. The filter element 10 includes an inner filter 14 and an outer filter 12. The inner filter 14 is placed concentrically within the outer filter 12. The inner filter 14 has a diameter less than the diameter of the outer filter 12. The inner filter 14 and the outer filter 12 are preferably corrugated. The inner filter is supported by an inner filter support 36. The outer filter 12 is supported by an outer filter support 38 therein. The liquid 22 passing therethrough is filtered by the inner filter 14 and the outer filter 12 causing any impurities to remain attached thereto. The liquid 23 filtered by the inner filter 14 flows radially inward through to the inner support 36. The liquid filtered by the outer filter 12 flows radially outward through the outer support 38. Upon the liquid flowing through the inner filter 14 and the outer filter 12, impurities 44 are left on the filter media thereby filtering the liquid 23. Generally, a high percent of impurities 44 are collected on a portion of the inner filter 14 and outer filter 12 that is closest to the second seal cap 30.

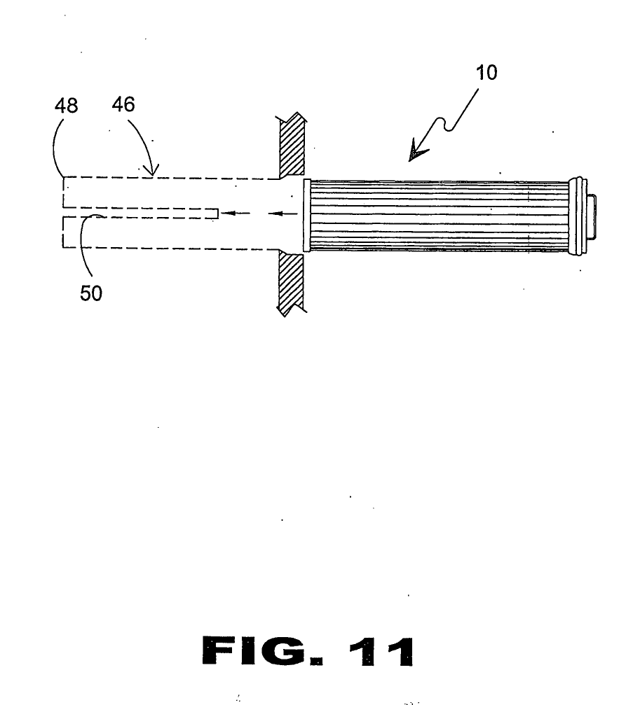

FIG. 11 is a front view of the filter element of the present invention having an alternate means for support. The alternate support 46 has an outer support 48 and an inner support 50. The outer support 48 and the inner support 50 have perforations extending therethrough for allowing liquid to pass freely therethrough. The alternate support 46 is designed to be integral with the housing 20 of the filter element. The inner filter 14 is positioned around the inner support 50 of the alternate support 46. The outer filter 12 is then positioned within the outer support 48 of the alternate support 46. The alternate support 46 remains within the housing 20 when filter element 10 is removed.

From the above description it can be seen that the filter element of the present invention is able to overcome the shortcomings of prior art restraint devices by providing a filter element for filtration of high capacity liquids by providing an inner filter held in place by an inner support and an outer filter held in place by an outer support, the inner and outer filters being positioned within a housing which receives high flow liquids that require filtration. Furthermore, the present invention is simple and easy to produce and use.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A filter cartridge element for high capacity liquid filtration comprising:
an outer filter having a first end and a second end;
an inner filter having a diameter smaller than a diameter of said outer filter and positioned within said outer filter forming an annular chamber wherein the annular chamber includes a radially inward filtering surface of a corrugated shape and a radially outward filtering surface of a corrugated shape;
an outer support member in contact with an outer surface of the outer filter;
an inner support member in contact with an inner surface of the inner filter;
a seal cap positioned on a first end of said outer filter;
a flow diverter positioned on a first end of the inner filter, said flow diverter being substantially recessed from the first end of the outer filter;
a cartridge removal handle connected to the seal cap:
at least one stabilizer protruding from the flow diverter; and
a second seal cap positioned on a second end of said inner and outer filters opposite said first seal cap, said second seal cap being secured to said second end of said inner and outer filters and said inner and outer support members and including an exit opening in fluid communication with the inner surface of the inner filter.

2. The filter element as recited in claim 1, wherein said inner support means includes perforations therearound.

3. The filter element as recited in claim 1, wherein said outer support means includes perforations therearound.

4. (canceled)

5. The filter element as recited in claim 1,
wherein said first seal cap comprises circular plate having a first side and a second side, the second side being in contact with the outer filter, the circular plate defining an opening in the center thereof;
wherein said flow diverter comprises a dome shape and a diameter substantially equal to a diameter of said inner filter; and
wherein said handle is connected to the first side of said circular plate, said filter stabilizer extends to and is connected to a second side of said circular plate opposite said connection to said handle.

6. The filter element as recited in claim 1, wherein said flow diverter comprises a dome.

7-11. (canceled)

12. The filter element as recited in claim 1, further comprising a housing surrounding said outer filter wherein said housing includes an inlet, and an outlet for filtered liquid to exit therefrom.

13. (canceled)

14. The filter element as recited in claim 1, further comprising:
an outer filter coupler positioned on said second end of said outer filter;
an inner filter coupler positioned on said second end of said inner filter;
a second inner filter connected to said inner filter coupler on a side opposite said inner filter; and
a second outer filter connected to said outer filter coupler on a side opposite said outer filter, wherein said second seal cap is positioned on a side of said second inner filter and second outer filter opposite said inner and outer filter couplers.

15-20. (canceled)

21. A cartridge element for filtering a liquid in a filter housing, the cartridge element comprising:
means for distributing a liquid to be filtered into an annulus chamber comprising a corrugated filtering inner surface and a corrugated filtering outer surface;
means for filtering, radially inward, a first portion of the liquid;
means for filtering, radially outward, a second portion of the liquid;
wherein solids remain in the annulus chamber; and
means for removing the solids together with the annulus chamber from the filter housing.

22. A cartridge element as in claim 21 wherein said means for distributing comprises a curved flow diverter.

23. A cartridge element as in claim 21 wherein said means for filtering radially inward comprises a corrugated inner filter member.

24. A cartridge element as in claim 23 wherein said inner filter member comprises an inner support surface.

25. A cartridge element as in claim 21 wherein said means for filtering radially outward comprises a corrugated outer filter member.

26. A cartridge element as in claim 25 wherein said outer filter member comprises an outer support structure.

27. A cartridge element as in claim 21 wherein said means for removing comprises a handle rigidly connected to the means for filtering radially inward and to the means for filtering radially outward.

28. A cartridge element as in claim 27 wherein said means for diverting includes a means for stabilizing connected to and protruding from the inner filter element.

29. A cartridge element as in claim 28 wherein said diverter resides within said outer filter element.

30. A cartridge element as in claim 21 wherein said inner filter element is recessed within said outer filter element.

31. A method of filtering liquid in a filter housing, the method comprising:
distributing a liquid to be filtered to an annulus chamber comprising a corrugated filtering inner surface and a corrugated filtering outer surface;
filtering, radially inward through the corrugated inner filter surface, a first portion of the liquid;
filtering, radially outward through the corrugated outer filter surface, a second portion of the liquid;
wherein solids remain in the annulus chamber; and
removing the solids together with the annulus chamber from the housing.
